(19) United States
(12) Patent Application Publication
(10) Pub. No.: US 2004/0250028 A1
(43) Pub. Date: Dec. 9, 2004

(54) Method and apparatus for data version checking

(76) Inventors: Rodger D. Daniels, Boise, ID (US); Brian Patterson, Boise, ID (US); Aaron Lindemann, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/457,895

(22) Filed: Jun. 9, 2003

(51) Int. Cl. G06F 12/00

(52) U.S. Cl. 711/156; 711/114

(57) ABSTRACT

A block of data is written to a location on a first storage system. Version checking data associated with the block of data and having a predetermined initial value is also written to the first storage system. The version checking data is then written to a second storage system. Upon subsequent writing of data to the same location on the first storage system, the version checking data on the first storage system is incremented and the incremented version checking data is stored on the second storage system. When reading the group of data from the first storage system, the data is validated by comparing the version checking data on the first storage system with version checking data on the second storage system.

### TECHNICAL FIELD

The systems and methods discussed herein relate to determining whether data is valid based on version checking data.

### BACKGROUND

Existing storage systems are available that use multiple storage devices to provide data storage with improved performance and reliability as compared to an individual storage device. For example, a Redundant Array of Independent Disks (RAID) system includes multiple disks that store data. RAID systems and other storage systems using multiple storage devices are able to provide improved reliability by using checksum information. Checksum information is extra data that is calculated and recorded to assure the validity of a certain block of data that is written to the multiple storage devices.

Checksum information is calculated based on the contents of a block of data. The checksum information is stored along with the block of data to allow detection of data corruption. When reading the block of data, a new checksum is calculated based on the data read from the storage device. The new checksum is calculated using the same mathematical formula as the checksum information stored with the block of data. This new checksum is compared to the checksum stored with the block of data. If the information in the two checksums match, the data read from the storage device is considered to be valid. If the information in the two checksums do not match, the data is corrupt.

Checksum information may also be transmitted with a block of data, thereby allowing the receiving system to verify that the data was not corrupted during the transmission process. Checksum information may include any number of bits and may be calculated using various techniques. Checksum calculation techniques include, for example, summing the bytes or words of the data block (ignoring overflow), or performing a bitwise XOR calculation on each bit in a specific position of a byte, which results in eight checksum bits (i.e., one for each bit of the byte).

A problem with checksum calculations is that their results are based on what is written on a storage device, such as a disk or other storage media. Data stored on the storage device is compared to the checksum information that is read from the same storage device. This approach is not capable of determining whether the data stored on the storage device is current data or old data. Thus, it is possible for a storage device to contain old data that is no longer valid, yet provide valid checksum information. For example, a block of data and an associated checksum is written to a storage device. The checksum stored on the storage device is valid for the block of data stored on the storage device. If the block of data is then rewritten with new data, a new checksum is calculated based on the new data and stored on the storage device along with the new data. However, during the writing of the new data and the new checksum information, an error occurs and neither the data nor the checksum information is actually written to the storage device. Although an error occurred, status information is returned by the storage device erroneously indicating that the write operation was successful. Thus, the system writing the data (or controlling the writing of data) is unaware of the error. A similar problem occurs if data is written to the wrong location on the storage device.

Although the system writing the data believes that the storage device contains the new data, the storage device actually contains the old data and old checksum information. This situation presents a problem because the data and the associated checksum information on the storage device are consistent and appear valid. Thus, a system reading the old data and associated checksum will calculate checksum information that matches the checksum information on the storage device, indicating valid data.

Accordingly, there exists a need for an improved system and method for validating data.

### SUMMARY

The systems and methods described herein write a block of data to a location on a first storage system. Version checking data associated with the block of data and having a predetermined initial value is written to the first storage system. The version checking data associated with the block of data is also written to a second storage system. Upon subsequent writing of data to the location on the first storage system, the version checking data on the first storage system is incremented and that incremented version checking data is stored on the second storage system.

In one embodiment, data is read from a first storage system. First version checking data is read from the first storage system. The first version checking data is associated with the data read from the first storage system. The first version checking data is validated with second version checking data stored on a second storage system.

### BRIEF DESCRIPTION OF THE DRAWINGS

The present invention is illustrated by way of example and not limitation in the figures of the accompanying drawings. These figures merely represent one or more possible embodiments of the invention. Similar reference numbers are used throughout the figures to reference like components and/or features.

FIG. 1 illustrates an exemplary environment in which a storage controller manages various data storage and data retrieval operations.

FIG. 2 is a block diagram of an exemplary storage controller capable of implementing the procedures discussed herein.

FIG. 3 is a flow diagram illustrating an embodiment of a procedure for writing data to a storage system.

FIG. 4 is a flow diagram illustrating an embodiment of a procedure for reading data from a storage system.

FIG. 5 illustrates an exemplary arrangement of data, including checksum and version checking information.

FIG. 6 illustrates an intended arrangement of data after a subsequent writing of new data to the same storage locations shown in FIG. 5.

FIG. 7 illustrates the actual arrangement of data after a failure of the subsequent writing of data to the same storage locations shown in FIG. 5.

FIG. 8 illustrates a version array containing version data associated with various data storage locations in a storage system.

FIG. 9 is a state diagram illustrating an embodiment of a sequence for incrementing version information after each write to the same location in a storage system.

### DETAILED DESCRIPTION

The systems and methods described herein determine whether a particular group of data is valid based on information contained in version checking information stored with the data and also stored on a second storage system. When reading data, the version checking information stored with the data is compared to the version checking information stored on the second storage system. If the version checking information matches, the data is considered to be valid. The version checking information may be used alone or in combination with checksum information.

Particular examples described herein discuss storage systems that utilize multiple disks and various error detection procedures. However, the systems and methods discussed herein can be applied to any type of storage device and any data storage technique. For example, storage devices may include disks, memory devices, or any other data storage mechanism. Further, any parity and/or data striping techniques can be utilized with the systems and methods discussed herein to provide for the reconstruction of data from a failed storage device. Particular storage systems may implement one or more RAID techniques for storing data across multiple storage devices. As used herein, references to “version checking data”, “version checking information”, “version data” and “version information” are used interchangeably.

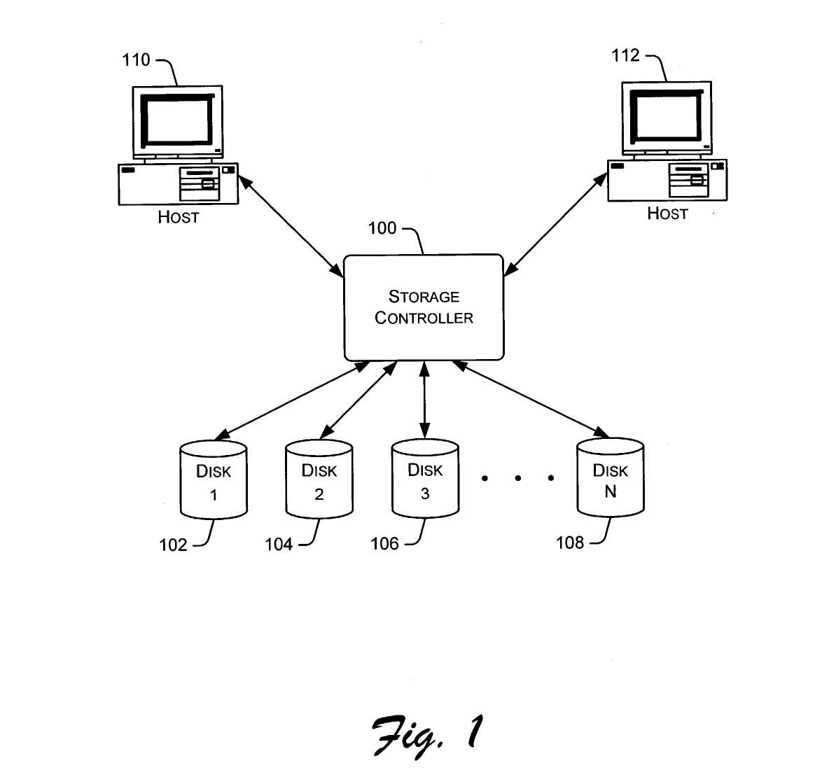

FIG. 1 illustrates an exemplary environment in which a storage controller 100 manages various data storage and data retrieval operations. Storage controller 100 receives data read requests and data write requests from one or more hosts 110 and 112. A host may be any type of computer, such as a workstation, a laptop computer, a handheld computer, or a server. Alternatively, a host may be any other type of computing device. Although FIG. 1 illustrates two hosts 110 and 112, a particular storage controller 100 may be coupled to any number of hosts.

Storage controller 100 is also coupled to multiple disks 102, 104, 106 and 108. A particular storage controller can be coupled to any number of disks or other storage devices. The number of active disks may change as existing disks fail or are removed from the system. Also, new disks may be added to the system (e.g., to increase storage capacity, to replace a failed disk, or to provide an additional spare disk) by a system administrator.

As discussed herein, storage controller 100 handles the storage and retrieval of data on the multiple disks 102-108. In a particular embodiment, storage controller 100 is capable of implementing various types of RAID (Redundant Array of Independent Disks) technology. Alternatively, storage controller 100 may implement other technologies or procedures that allow data to be reconstructed after a storage device fails. Storage controller 100 also verifies data read from the multiple disks 102-108 using various data verification techniques. Storage controller 100 may be a separate device or may be part of a computer system, such as a server. Additionally, disks 102-108 may be located in the same device as storage controller 100 or in a separate device coupled to storage controller 100. In one embodiment, disks 102-108 have approximately equal storage capacities.

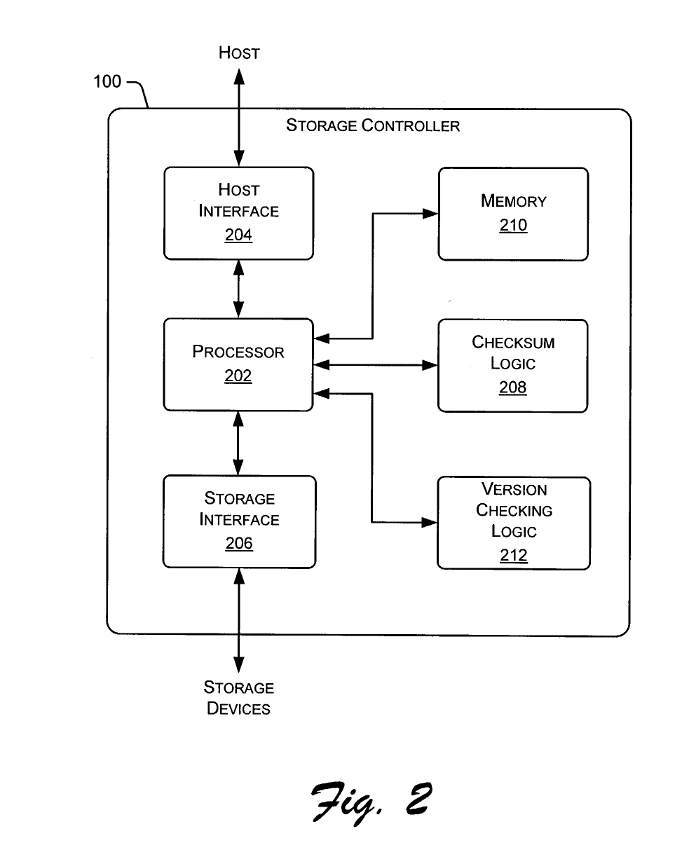

FIG. 2 is a block diagram of storage controller 100, which is capable of implementing the procedures discussed herein. A processor 202 performs various operations and tasks necessary to manage the various data storage and data retrieval requests received from hosts 110 and 112 (FIG. 1). Additionally, processor 202 performs various functions to validate data, manage version checking information and reconstruct lost data, as described herein.

Processor 202 is coupled to a host interface 204, which provides a bidirectional data communication interface to one or more hosts. Processor 202 is also coupled to a storage interface 206, which provides a bidirectional data communication interface to multiple disks or other storage devices. Checksum logic 208 is coupled to processor 202 and provides processor 202 with the logic necessary to calculate checksum information and validate data based on the checksum information. Checksum logic 208 may include multiple checksum algorithms or formulas depending on the types of checksum calculations supported by storage controller 100. In other embodiments, checksum logic 208 may be coupled to host interface 204, storage interface 206, one or more hosts, or a storage device (such as a backend disk drive). Alternate embodiments of storage controller 100 omit checksum logic 208.

Memory 210 is also coupled to processor 202 and stores various information used by processor 202 when carrying out its tasks. Memory 210 may include volatile memory, non-volatile memory, or a combination of volatile and non-volatile memory. Memory 210 may store version checking information that is verified against version checking information stored with data on a disk. Processor 202 is further coupled to version checking logic 212, which contains one or more techniques for utilizing version checking information to identify invalid data, as discussed herein.

The embodiment of FIG. 2 represents one possible configuration of storage controller 100. It will be appreciated that various other storage controller configurations can be used to implement the procedures discussed herein.

As mentioned above, in a particular embodiment, storage controller 100 is capable of implementing RAID technology. RAID systems use multiple storage devices (e.g., disks) in combination with parity data to improve reliability and fault tolerance.

FIG. 3 is a flow diagram illustrating an embodiment of a procedure 300 for writing data to a storage system. Initially, procedure 300 identifies a block of data to be stored (block 302) on a storage system containing one or more storage devices. A “block” of data can be any amount of data, such as a single bit of data, several bytes of data, or several thousand bytes of data. The data in a particular “block” may be stored in contiguous storage locations on a storage device or may be stored in multiple locations on a storage device. In another embodiment, data in a “block” may be stored in multiple locations across multiple storage devices (e.g., using RAID techniques or other data storage procedures).

Procedure 300 continues by writing the received block of data to a location on a first storage system (block 304). In this example, the first storage system is a storage disk. The procedure then calculates checksum information associated with the block of data (block 306). A variety of different algorithms may be used to calculate the checksum information. In a particular implementation, a bitwise XOR calculation is used to generate checksum information. The checksum information is then written to the first storage system (block 308).

At block 310, a version checking bit is written to the first storage system. The same version checking bit is also written to a second storage system (block 312), such as a memory device in a storage controller. Alternatively, the second copy of the version checking bit can be stored in a different location of the first storage system, on a different storage controller or on a storage device outside of the storage controller.

The version checking bit has a predetermined initial value, such as “1”. Although the example described with respect to FIG. 3 uses a single version checking bit, alternate embodiments can use any number of version checking bits, as discussed below.

The procedure then monitors the first storage system for a request to write a new (or updated) block of data to the same location on the first storage system (block 314). When such a request is received, procedure 300 calculates checksum information associated with the new (or updated) data and writes the checksum information to the first storage system along with the new data (block 316). The procedure then increments the value of the version checking bit on the first storage system (block 318) and stores the incremented version checking bit on the second storage system (block 320). For example, if the version checking bit was previously set to “1”, incrementing the bit changes its value to “0”. Similarly, if the version checking bit was previously set to “0”, incrementing the bit changes its value to “1”. In an alternate embodiment, procedure 300 increments the value of the version checking bit on the second storage system at block 320 instead of storing the value of the incremented version checking bit stored on the first storage system.

Incrementing the version checking bit allows a device, such as a storage controller, to identify invalid data. For example, the first time data is written to the first storage system, the version checking bit is also written to the first storage system. Additionally, the version checking bit is written to a second storage system, which is different from the first storage system. If new or updated data is written to the same location on the first storage system, the version checking bit on the first storage system is incremented and that incremented value is stored on the second storage system. If the new data was properly stored on the first storage system, then the two version checking bits should match. However, if the new data was not properly stored on the first storage system, the version checking bit on the first storage system would not have been incremented. Thus, the two version checking bits will not match, indicating invalid data. Additional details regarding using the version checking bits are provided below.

Although writing the block of data, writing the checksum information and writing the version checking bit to the first storage system are identified as separate blocks in FIG. 3, all three items are typically written to the first storage system in a single write operation. Similarly, writing new data, writing new checksum information and incrementing the version checking bit are typically performed in a single write operation.

Although particular examples are discussed herein as using both checksum information and version checking information, in alternate embodiments, systems and methods may implement the version checking techniques described herein without using checksum information.

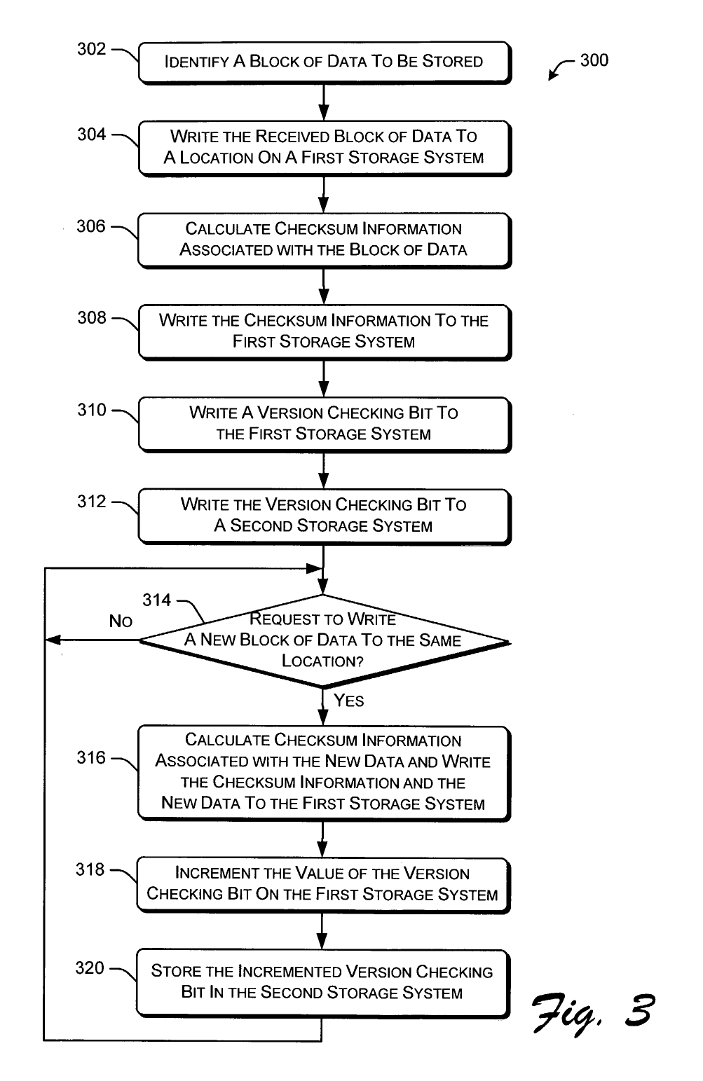

FIG. 4 is a flow diagram illustrating an embodiment of a procedure 400 for reading data from a storage system. Initially, the procedure receives a request to read a block of data (block 402). The requested block of data is read from a first storage system (block 404). Additionally, checksum information associated with the block of data is read from the first storage system (block 406). The procedure then reads a first version checking bit associated with the block of data from the first storage system (block 408). Next, the procedure reads a second version checking bit associated with the block of data from a second storage system (block 410).

At block 412, procedure 400 determines whether the checksum information read from the first storage system is valid. For example, a checksum algorithm can be applied to the block of data read from the first storage system. If the results of the checksum algorithm do not match the checksum information read from the first storage system, the data is corrupted. If the determination at block 412 concludes that the checksum information is not valid, the procedure generates a checksum error message (block 414).

If the checksum information is validated, the procedure continues to block 416 to determine whether the version checking bits match. The procedure compares the value of the version checking bit read from the first storage system with the value of the version checking bit read from the second storage system. If the version checking bits do not match, the procedure generates a data version error message (block 418). Additionally, if the version checking bits do not match, the procedure may initiate a data reconstruction process in an attempt to reconstruct the block of data that should have been read from the first storage system. For example, in a RAID 1 stripe of data, if one copy of the data agreed with the version data and another copy didn't agree with the version data, the data that agreed with the version data in the second memory system could be considered valid and then used to correct the invalid data.

If the version checking bits match at block 416, the block of data read from the first storage system is considered valid and is provided to a host that generated the request to read the data (block 420). Procedure 400 is repeated for subsequent requests to read data from the first storage system.

In alternate embodiments of procedure 400, the version checking bits may be compared (block 416) prior to validating the checksum information (block 412). This ordering is particularly useful if the version checking bits can be prepared faster than the checksum can be calculated and validated. Additionally, other embodiments of procedure 400 may compare the version checking bits (block 416) before reading the requested block of data from the first storage system (block 404), thereby saving the data reading time if the version checking bits do not match.

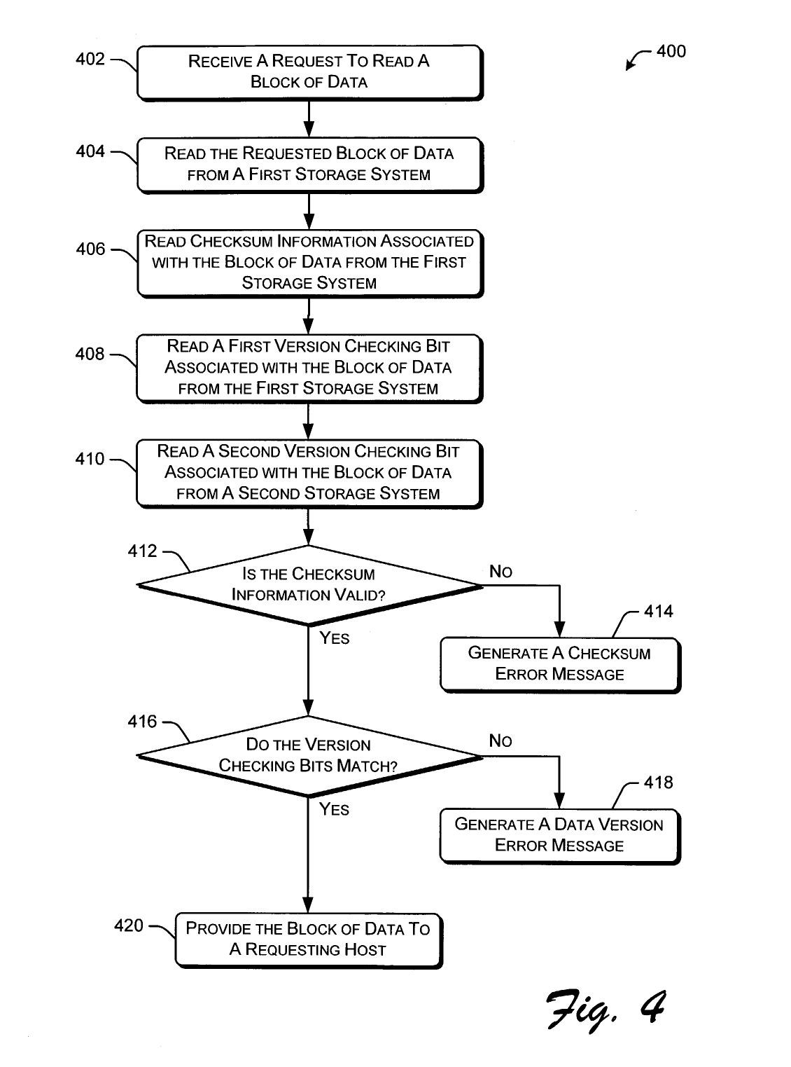

FIG. 5 illustrates an exemplary arrangement of data, including checksum and version checking information. The illustrated block of data in FIG. 5 contains five bytes, with each byte having eight bits. Thus, the block of data represents 40 bits of data. The arrangement shown in FIG. 5 is provided for explanation purposes. In alternate embodiments, a block of data may contain any number of data bits arranged in any configuration. A particular block of data contains 512 bytes of data in which each byte of data includes eight bits.

The checksum information shown in FIG. 5 represents the results of a bitwise XOR calculation performed on each column of bits. Each column of bits represents a particular bit position (e.g., “bit 1”, “bit 2”, etc.) in each byte. For example, the first column that represents the “bit 1” position has a checksum value of “0”. This checksum is calculated by performing an XOR operation on the first two bits in the column: 1 XOR 1=0. Another XOR operation is performed on the result (0) and the next bit (i.e., the bit associated with Byte 3), which is “0”. So, 0 XOR 0=0. This result (0) is used along with the next bit (1): 0 XOR 1=1. That result (1) is used along with the last bit in the column (1): 1 XOR 1=0. Thus, the checksum value for the first column is “0”. A similar procedure is performed on each column to create eight bits of checksum information.

As shown in FIG. 5, a version bit 502 is stored adjacent the checksum information. In alternate embodiments, version bit 502 can be stored in any location on the storage system with the associated data. Another version bit 504 shown in FIG. 5 is stored on a second storage system. For example, the data, checksum information and version bit 502 are stored on a particular storage system (also referred to as a first storage system). The second version bit 504 is stored, for example, in a memory device in a storage controller that controls the first storage system. The second version bit 504 is shown in the proximity of information stored on the first storage system for purposes of explanation. FIG. 5 represents the status of the data, checksum information and version bits after data is written to the first storage system.

FIG. 6 illustrates an intended arrangement of data after a subsequent writing of new data to the same storage locations shown in FIG. 5. If the new data had been written to the first storage system correctly, the information shown in FIG. 6 would be accurate. For example, the checksum information would be updated based on the new data. Additionally, both version bits 502 and 504 would be updated by incrementing their values from “1” to “0”. However, a failure in the data write operation prevents the arrangement of data in FIG. 6 from being realized.

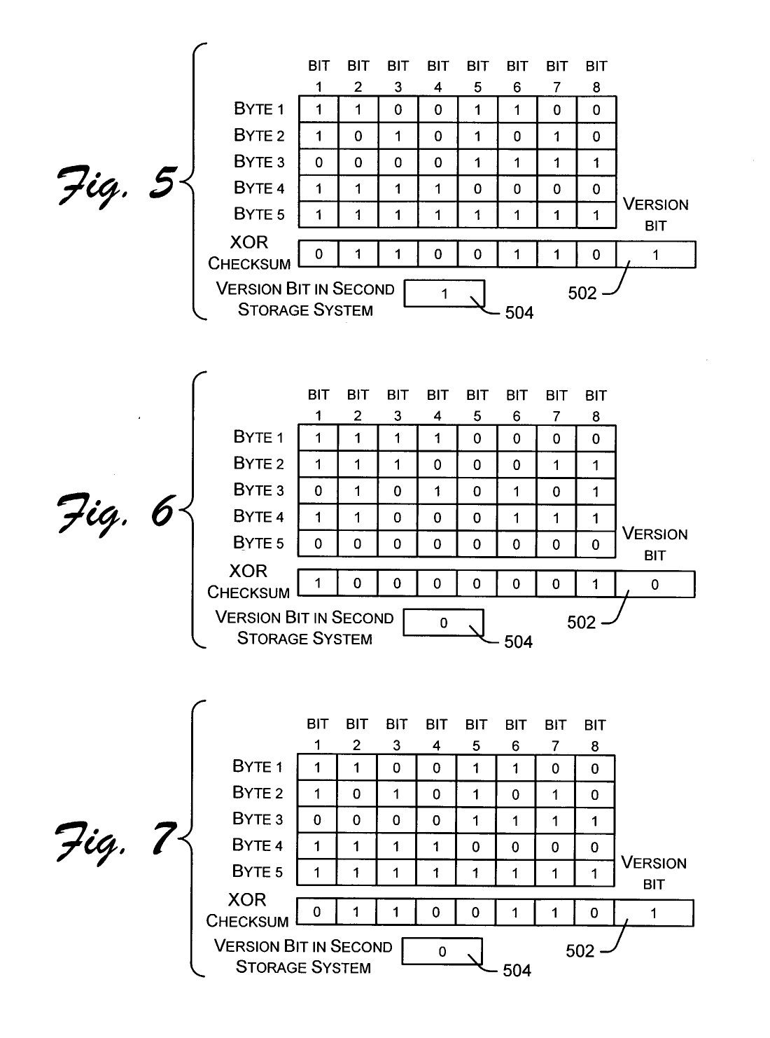

FIG. 7 illustrates the actual arrangement of data after a failure of the subsequent writing of data to the same storage locations shown in FIG. 5. As shown in FIG. 7, the data and the checksum information on the first storage system have not changed (i.e., the data and checksum information is the same as FIG. 5). However, the first storage system erroneously reported back to the storage controller that the new data was properly recorded on the first storage system. Thus, the storage controller has no reason to believe that the new data was not written to the first storage system.

As shown in FIG. 7, the checksum information stored on the first storage system remains valid for the old data. This old data may be referred to as “stale” data. However, since the new data was not properly written to the first storage system, version bit 502 was not incremented. Thus, version bit 502 is unchanged with a value of “1”, which is the same value as shown in FIG. 5. Since the storage controller believes that the new data was correctly written to the first storage system, the value of version bit 504 was changed to “0” to match the incremented value of version bit 502. Thus, the values of the two version bits 502 and 504 in FIG. 7 do not match. This mismatch of version bit values will notify a system or device reading the data that the data is not valid. For example, a storage controller reading data from the first storage system will realize that the value of version bit 502 on the first storage system does not match the value of version bit 504 stored in a memory device in the storage controller.

Thus, although the checksum information shown in FIG. 7 is valid for the data shown in FIG. 7, the stale data is not valid. In this situation, using version checking bits as described herein detects the invalid data and allows the valid data to be retrieved by initiating a data reconstruction process.

As discussed herein, certain embodiments increment two copies of the version checking data on two different storage devices or in two different locations of the same storage device. Other embodiments increment one copy of the version checking data and store a second copy of the incremented data on a different storage device or in a different location on the same storage device. Examples discussed herein increment the version checking data value on the first storage device and store that incremented value on a second storage device. In alternate embodiments, the version checking data value stored on the second storage device is incremented and that incremented value is stored on the first storage device. In this alternate embodiment, data is typically read faster from the second storage device, so the system reads and increments that data, thereby improving the overall speed of the system.

In a system in which both the first storage device and the second storage device provide approximately equal data access times, the version checking data is read from the storage device that is least busy at that time. Thus, the version checking data may be read from different storage devices as the utilization of the storage devices changes.

In a particular implementation, the version checking data stored in a non-volatile random access memory (RAM) is read and incremented first. The new version checking data value is then written to both the non-volatile RAM and the storage disks along with the new data and the associated checksum value.

The examples discussed above include a single bit of version data. If two successive write operations to the same data storage location fail before the group of data is read from the storage system, the version data will indicate valid data even though the data is stale. The two successive write operations will cause the version data on the second storage system to change twice, bringing the one-bit value back to the same value stored on the first storage system. Although this situation is unlikely, it results in the erroneous reading of invalid data.

To decrease the likelihood of having matching version checking data when the data is stale, multiple bits can be used to represent the version checking data. For example, if two version checking data bits are used, four (2²) successive failed write operations would be required prior to a read operation of the same group of data to generate invalid data. Similarly, if three version checking data bits are used, eight (2³) successive failed write operations would be required prior to a read operation of the same group of data to generate invalid data.

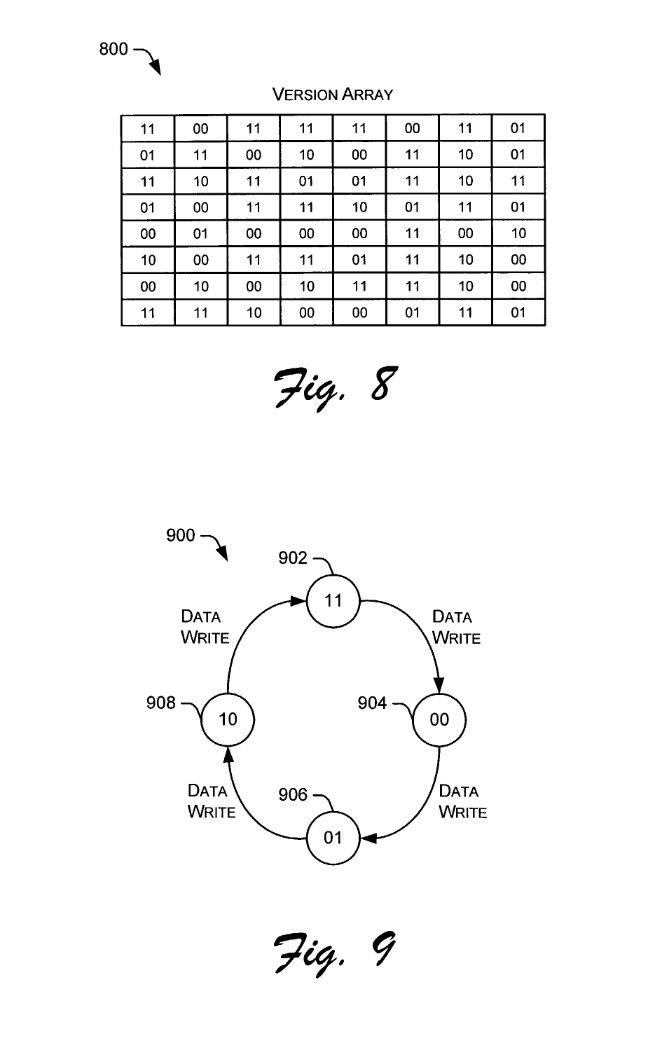

FIG. 8 illustrates a version array 800 containing version data associated with various data storage locations in a storage system. The version data stored in version array 800 contains two bits of data. Alternate embodiments of the version array may contain version data having any number of bits. Each entry in the version array is associated with a particular block of data stored on a storage system. Corresponding version data is stored with each block of data. When data is read from the storage system, the version data stored with the block of data is compared to the corresponding version data stored in version array 800. If the two version data values match, the data read from the storage system is considered to be valid. Version array 800 is stored on a separate storage system from the associated blocks of data. In one embodiment, version array 800 is stored in a memory device in a storage controller that handles the storage and retrieval of the blocks of data. Version array 800 includes eight columns and eight rows. Alternate implementations of version array 800 may contain any number of columns and rows, depending on the number and arrangement of the blocks of data associated with the version array.

A particular embodiment of version array 800 is capable of storing version data for each block of data in an associated storage system. The version array is addressed by the data block address used to identify blocks of data.

FIG. 9 is a state diagram illustrating an embodiment of a sequence 900 for incrementing version data after each write to the same location in a storage system. Sequence 900 is used to increment version data stored on the storage system with the associated data. That same version data is also stored on a second storage system (e.g., in the storage controller).

When data is first written to a location on the storage system, the associated version data is initially set to a predetermined value, such as “11”, represented by a state 902. This initial predetermined value can be any state in sequence 900. If the current state is 902, the next data write operation to the same storage location causes the state to advance to a state 904, which causes the associated version data to increment to “00”. Both the version data stored with the data on the storage device and the version data stored on a second storage device are updated to “00”. The next write operation to the same storage location causes the state to advance to a state 906, thereby causing the version data to increment to “01”. Another write operation to the same storage location causes the state to advance to a state 908, causing the version data to increment to “10”. The next write operation to the same storage location causes the state to advance to state 902, causing the version data to increment to “11”. The sequence continues in this manner after each successive write operation to the same storage location.

Various examples discussed herein store copies of the version checking data on two different storage devices. In other embodiments, the two copies of the version checking data can be stored on the same storage device (such as a disk, memory, or other device capable of storing data). For example, the two copies of the version checking data may be stored in different locations of the storage device and written to the storage device in two separate operations. The manner in which the version checking data is incremented and updated on the storage device is similar (or identical) to the procedures discussed herein with respect to using two different storage devices. When writing the two copies of the version checking data to different locations on the same storage device, two separate write operations are performed, thereby decoupling failures during either write operation.

Particular examples discussed herein relate to data error detection on a storage system, such as an array of disks. However, the systems and methods discussed herein can be used in other environments, such as host/array interactions. In a host/array environment, a version array would be located on a host device and the version data would be written to the storage array along with the data. When the host reads from the storage array, it would check to see that the version data in the version array matched the version data read with the data from the storage array.

Although the description above uses language that is specific to structural features and/or methodological acts, it is to be understood that the method and apparatus for data error detection defined in the appended claims is not limited to the specific features or acts described. Rather, the specific features and acts are disclosed as exemplary forms of implementing the systems and methods described herein.

1. A method comprising:
writing a block of data to a location on a first storage system;
writing version checking data associated with the block of data to the first storage system, wherein the version checking data has a predetermined initial value;
writing the version checking data associated with the block of data to a second storage system; and
upon subsequent writing of data to the location on the first storage system:
incrementing the version checking data on the first storage system; and
storing the incremented version checking data on the second storage system.

2. A method as recited in claim 1, further comprising writing checksum information associated with the block of data to the first storage system.

3. A method as recited in claim 1, wherein writing the block of data and writing the version checking data to the first storage system is performed in a single operation.

4. A method as recited in claim 1, wherein the first storage system is an array of disks.

5. A method as recited in claim 1, wherein the second storage system is a memory device in a storage controller coupled to the first storage system.

6. A method as recited in claim 1, wherein the second storage system is a non-volatile memory device.

7. A method as recited in claim 1, wherein the version checking data is a single bit of data.

8. A method comprising:
writing a block of data to a first location on a storage system;
writing version checking data associated with the block of data to the first location on the storage system, wherein the version checking data has a predetermined initial value;
writing the version checking data associated with the block of data to a second location on the storage system; and
upon subsequent writing of data to the location on the first storage system:
incrementing the version checking data stored at the first location on the storage system; and
storing the incremented version checking data at the second location on the storage system.

9. A method as recited in claim 8, wherein writing a block of data and writing version checking data associated with the block of data is performed in a single operation.

10. A method comprising:
reading data from a first storage system;
reading first version checking data from the first storage system, wherein the first version checking data is associated with the data read from the first storage system; and
validating the first version checking data with second version checking data stored on a second storage system.

11. A method as recited in claim 10, wherein validating the first version checking data includes:
reading second version checking data from a second storage system; and
determining whether the first version checking data matches the second version checking data.

12. A method as recited in claim 10, further comprising generating a version error message if the version checking data is not validated.

13. A method as recited in claim 10, further comprising initiating a data reconstruction process if the version checking data is not validated.

14. A method as recited in claim 10, further comprising reading checksum information from the first storage system, wherein the checksum information is associated with the data read from the first storage system.

15. A method as recited in claim 14, further comprising validating the checksum information using the data read from the first storage system.

16. A method as recited in claim 10, wherein the first storage system is a disk and the second storage system is a memory device in a storage controller coupled to the first storage system.

17. One or more computer-readable media having stored thereon a computer program that, when executed by one or more processors, causes the one or more processors to:
write a block of data to a location on a first storage system;
write version checking data to the first storage system, wherein the version checking data is associated with the block of data and has a predetermined initial value;
write the version checking data to a second storage system; and
upon subsequent writes of data to the location on the first storage system, increment the version checking data on the first storage system and store the incremented version checking data on the second storage system.

18. One or more computer-readable media as recited in claim 17, wherein the first storage system is a plurality of disks and the second storage system is a memory device.

19. One or more computer-readable media as recited in claim 17, wherein the block of data and the version checking data is written to the first storage system in a single operation.

20. An apparatus comprising:
a storage interface coupled to a plurality of storage devices;
version checking logic; and
a processor coupled to the storage interface and the version checking logic, wherein the processor is configured to read data from a first storage system and read first version checking data from the first storage system, wherein the first version checking data is associated with the data read from the first storage system, and wherein the processor is further configured to read second version checking data from a second storage system and validate the first version checking data with the second version checking data.

21. An apparatus as recited in claim 20, wherein the processor is configured to initiate a data reconstruction process if the version checking data is not validated.

22. An apparatus as recited in claim 20, wherein the second storage system is a memory device in a storage controller coupled to the first storage system.
